(19) United States
(12) Patent Application Publication
(10) Pub. No.: US 2022/0138298 A1
(43) Pub. Date: May 5, 2022

(54) DEVICE AND SYSTEMS FOR STRONG IDENTITY AND STRONG AUTHENTICATION

(71) Applicants: LOGIN ID INC., San Mateo, CA (US); IPSIDY INC., Long Beach, NY (US)

(72) Inventors: Simon LAW, San Mateo, CA (US); Pasan Chankama HAPUARACHCHI, San Anselmo, CA (US); Phillip L. KUMNICK, St. Albans, MO (US); Thomas R. SZOKE, Apopka, FL (US); Maxim UMAROV, Weston, FL (US)

(21) Appl. No.: 17/519,656

(22) Filed: Nov. 5, 2021

Related U.S. Application Data
(60) Provisional application No. 63/109,910, filed on Nov. 5, 2020.

(51) Int. Cl. G06F 21/32; G06F 21/44

(52) U.S. Cl. CPC G06F 21/32; G06F 21/44

(57) ABSTRACT

Verifying identity of a person using remote communication (e.g., Internet) is difficult because images of identity documents can be fraudulent or copied and distributed to adversaries without the person's permission. A user device and a server use facial scanning to verify identity of a person and to provide strong authentication. The user device captures a scanned image of an identity document (e.g., a driver license, a passport, a credential document, etc.) extracts the photo of the person from the identity document. The user device also captures an image of the person's face (e.g., a selfie photo) and compares this image with the extracted photo from the identity document. If the faces match, then the person's identity is verified. The verification of the identity and a related action (e.g., registration of the person, logging into a system, etc.) are authenticated using strong authentication such as Fast Identity Online (FIDO) authentication.

### CROSS-REFERENCE TO RELATED APPLICATION

This patent application claims priority to U.S. Provisional Patent Application No. 63/109,910, titled “DEVICE AND SYSTEMS FOR STRONG IDENTITY AND STRONG AUTHENTICATION”, filed on Nov. 5, 2020, the entire contents of which are incorporated herein by reference.

### TECHNICAL FIELD

The following generally relates to the integrated use of biometrics for strong identity and strong authentication.

### DESCRIPTION OF THE RELATED ART

People interact with organizations (e.g., government entities, healthcare organizations, education systems, companies, payment systems, etc.) and at times they need to provide identification about themselves. In an example registration process, a person will bring a document that is considered an identity document to the organization for verification. For example, the identity document is a driver's license, a passport, a national identity card, a birth certificate, a diploma, a citizenship card, a health card, a social insurance card, etc. The organization review the identity document and, after the organization verifies the identity document, the organization creates an account for the person. The person and the organization can then carry out actions.

In some cases, the identity document has a photograph of the person and the organization's personnel manually look at the photograph of the person on the identity document and compare it with what they see when they look at the person in front of them. For example, a voting officer will look at a person's driver license card and also look at the person to make sure the photo on the driver license matches the face of the person. If so, the person is considered to be who they claim to be and can proceed to vote. In another example, when a person wants to register for a bank account, they will need to bring photo identification like a driver license to the bank, and the bank personnel will verify that the photo on the driver license matches the person, before opening up a bank account for the person.

However, these protocols of manually verifying photo documents are personnel intensive and require a person to provide physical documents, often in person. This is time consuming for the person, and in some cases not practical. For example, if the person cannot provide the physical identity document in person. In a further example, due to social distancing due to virus spread or other travel restrictions, it is difficult or not possible for a person to bring their physical identity document in person to an organization for verification.

A person can send a digital photograph of their identity document to the organization, but this approach is prone to fraud. It is difficult for the organization to verify if the digital photograph of the identity document is a copy of a genuine document and does truly belong to the person who sent the digital photograph.

The above problems, amongst other challenges, make it difficult to facilitate user authenticated actions (e.g., logging in, viewing data, executing a transaction, etc.) via websites, apps, user accounts, etc. in a scalable and digital manner.

### BRIEF DESCRIPTION OF THE DRAWINGS

Embodiments will now be described by way of example only with reference to the appended drawings wherein:

FIG. 1 is a schematic diagram of an example of a system of user devices and server systems that include, for example, an ID server, a Service Provider server and a trusted verifier server.

FIG. 2A is a flow diagram of example computer executable or processor implemented instructions for a user device to register a user using facial scanning and Fast Identity Online (FIDO) authentication. FIG. 2B is a flow diagram of example computer executable or processor implemented instructions for a user device to register a user, which is an alternative example embodiment to the process in FIG. 2A. FIG. 2C is a flow diagram of example computer executable or processor implemented instructions for a user device to perform a follow up action (e.g., logging in or some other action) after registration is complete.

FIG. 3 is a flow diagram of computer executable or processor implemented instructions for a user device and a server to execute a registration process using facial scanning and FIDO authentication according to another example embodiment.

FIG. 4 is a flow diagram of computer of example computer executable or processor implemented instructions for a user device and a server to, after registration is complete, perform follow-up authentication and a follow-up action, according to an example embodiment.

FIG. 5 is a flow diagram of computer of example computer executable or processor implemented instructions for a user device and a server to, after registration is complete, perform follow-up authentication using facial scanning and to perform a follow-up action, according to an example embodiment.

FIGS. 6A, 6B, 6C, 6D, 6E, 6F, 6G, 6H, and 6I are example screenshots of a graphical user interfaces (GUI) for a registration process that uses facial scanning, according to an example embodiment.

FIG. 7 are example image frames of a user's face when capturing a picture of themselves, and the movement in the user's face is used for detecting that the person is live with the user device, according to an example embodiment.

FIGS. 8A, 8B, 8C, and 8D are example screenshots of a GUI for performing a follow-up authentication and a follow-up action after registration is complete, according to an example embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Within this specification, different structural entities (which may variously be referred to as “component”, “circuit”, “system”, “processor”, “module”, “interface”, “device”, other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform one or more tasks during operation. A structure can be said to be “configured to” perform some task even if the structure is not currently being operated. A “biosensor configured to collect biometric information” is intended to cover, for example, an integrated circuit that has circuitry that performs this function during operation, even if the integrated circuit in question is not currently being used (e.g., a power supply is not powering it). Thus, an entity described or recited “configured to” perform some task refers to something physical, such as a device, circuit, memory storing program instructions executable to implement the task, etc. This phrase is not used herein to refer to something intangible. Thus, the “configured to” construct is not used herein refer to a software entity, such as an application programming interface (API).

The term “configured to” is not intended to mean “configurable to.” An unprogrammed Field Programmable Gate Array (FPGA), for example, would not be considered to be “configured to” execute some specific operation, although it may be “configurable to” perform that specific operation and may be “configured to” execute that specific function after programming.

Reciting in the appended claims that a structure is “configured to” perform one or more tasks is intended not to be interpreted as having means-plus-function elements.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this specification, numerous specific details have been set forth. It is to be understood, however, that implementations of the disclosed technology may be practiced without these specific details. In other instances, well-known methods, structures, and techniques have not been shown in detail in order not to obscure an understanding of this description. References to “for example”, “some examples,” “other examples,” “one example,” “an example,” “various examples,” “one embodiment,” “an embodiment,” “some embodiments,” “example embodiment,” “an example aspect”, “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Devices, systems and processes are herein provided for using biometrics for strong identity and strong authentication to execute an action. For example, strong identity and strong authentication processes are integrated into a single session. The action, for example, can be to access a database, log into an online platform, execute a transaction, etc.

It is herein recognized that verifying an identity of a person using remote communication (e.g., Internet, cell networks, etc.) is difficult because images of identity documents can be fraudulent or copied and distributed to adversaries without the person's permission. Therefore, a user device and a server are provided, which use facial scanning to verify identity of a person and to provide strong authentication. The user device captures a scanned image of a trusted identity document (e.g., a driver license, a passport, a national identity document, a credential document, etc.) extracts the photo of the person from the identity document. The user device also captures an image of the person's face (e.g., a selfie photo) and compares this image with the extracted photo from the identity document. If the faces match, then the person's identity is verified. The verification of the identity and a related action (e.g., registration of the person, logging into a system, etc.) are authenticated using strong authentication. An example of strong authentication is Fast Identity Online (FIDO) authentication.

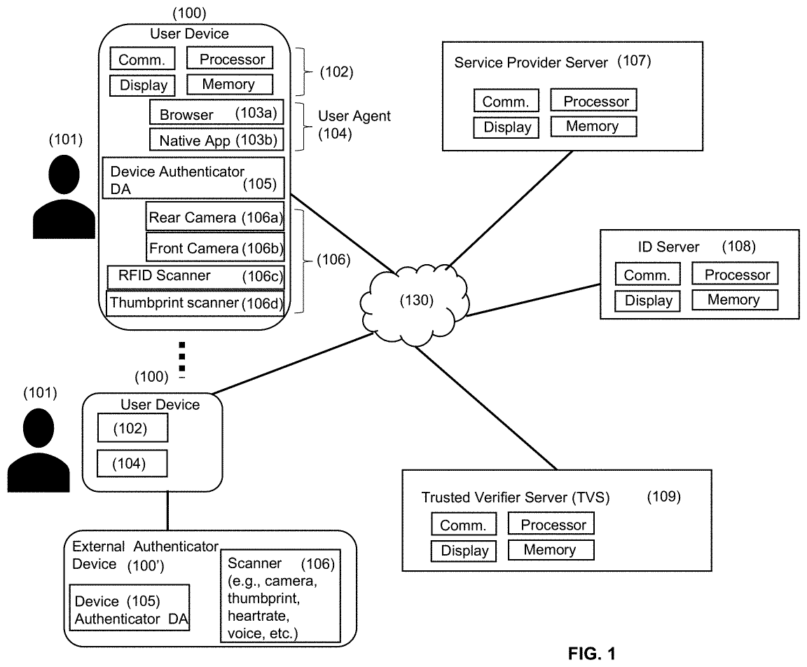

Turning to FIG. 1, the computing architecture includes one or more users 101 and their user devices 100. Examples of user devices include mobile devices, laptops, desktop computers, tablets, smart phones, smart watches, etc. Some examples of user devices include devices from Apple®, any other user device running Apple's iOS® operating system, any other user device running Google's Android® operating system, and any other user device running Microsoft's Windows® operating system. Other user devices that run other types of currently-known and future-known operating systems can also be used according the principles described herein.

A user device 100 includes hardware components 102, examples of which include a processor, memory, a communication module (e.g., for communicating via a cell network, WiFi, LAN, WAN, etc.), and a user interface (e.g., display screen, touch interface, keyboard, mouse, etc.). These hardware components 102 can vary in type, number and architecture as user devices continue to develop. In an example aspect, the user device 100 includes a browser 103a, or a native application (also called an app) 103b, or both. The browser 103a or the native app 103b, or both, are more generally herein referred to as the user agent 104. The user agent 104 displays a graphical user interface (GUI) on a display screen to guide the user through the authentication process and the related action (e.g., logging in, executing a command, a transaction, accessing data, etc.).

The user device also has a device authenticator (DA) 105, which is used to store user-identifying data on the device a secure manner and to authenticate the user. In an example aspect, the device authenticator 105 includes a secure execution and secure storage environment, which can be implemented using one or more of: a Trusted Execution Environment (TEE); a secure element, a firewall; a software layer; a secure enclave; a Hardware Secure Module (HSM); etc. It will be appreciated that a TEE is a computing chip that, for example, exists on a processor device. It will be appreciated that a HSM is a separated computing appliance. Authentication data about a user 101 can be stored in the device authenticator. The authentication data about the user, for example, includes a device authentication private key (also referred to as a DA private key) associated with the user 101 and the device authenticator 105 of the device 100. In an example aspect of using the FIDO protocol, the DA private key is known as a FIDO private key. The device authenticator may also store other data, including, but not limited to: biometric authentication data, passwords, security codes, name, address, account numbers (e.g., like a primary account number (PAN), driver's license number, etc.), age, date of birth, citizenship, credentials, etc.

The user device may also include one or more scanners 106. Examples of scanners 106 includes a rear camera 106a, a front camera 106b, a radio frequency identification (RFID) scanner 106c, a thumbprint scanner 106d, a heartrate monitor, a microphone for voice detection, etc. A rear camera 106a is positioned on the rear-facing surface of the user device and faces away from the user 101 when the user is looking at the display screen. A front camera 106b is positioned on the front-facing surface of the user device and faces towards the user 101 when the user is looking at the display screen. In an example embodiment, a face scanning system includes a dot projector that projects infrared dots on a person's face and an infrared camera takes an image of the face and the dots. It is appreciated that currently known and future known scanners can be used to verify that the correct person is truly interacting with their user device.

The device authenticator 105, for example, interacts with a scanner 106 to obtain identifying data about the user, and compares the scanned identifying data about the user with stored identifying data about the user. For example, the identifying data about the user is biometric authentication data, including and not limited to one or more of: fingerprint scan, eye scan, facial recognition, voice recognition, heartbeat or pulse monitoring, DNA sampling, body temperature, etc. The scanner 106 includes one or more sensors that can capture the biometric authentication data. In other words, in an example aspect, a type of scanner 106 of the user device includes a biometric sensor or biosensor for collecting biometric data.

In preferred example embodiments, the processes described herein use a scanner 106. It will also be appreciated that the identifying information about the user can include data that is not biometric in nature.

In an example embodiment, the device authenticator 105 and the one or more scanners 106 are built into the user device 100.

In another example embodiment, the device authenticator 105 and the scanner 106 are part of an external authenticator device 100′. The user device 100 and the external authenticator device 100′ are in data communication with each other. For example, the external authenticator device 100′ is connected to the user device 100 via a wire or some other electrical connection (e.g., universal serial bus (USB)). In another example, the external authenticator device 100′ is connected to the user device 100 via wireless communication. Examples of wireless communication include the Bluetooth, Near Field Communication, and WiFi. Example embodiments of an external authenticator device 100′ include a smart watch, a USB key, a dongle, and a smart phone. The term “user device” collectively refers to the user device 100 and an external authenticator device 100′, in embodiments that include an external authenticator device.

The one or more user devices 100 are in data communication with a data network 130. The system also includes other servers 107, 108, 109 which are also in data communication with the data network 130. The terms “server” and “Server” each herein refers to a computing system that can include one server computer or multiple server computers that are networked to operate together. A server includes one or more processors, memory, and a data communication module for connecting to the network 130. A server also includes software and other logic modules for storing data and executing instructions. A server can also be connected to a display device.

The service provider server 107 operates an interface for conducting operations with the user device 100. For example, the service provider server 107 is a relying party that relies on the data verification and user authentication provided by the other servers. The service provider server, for example, is an organization (e.g., bank, government entity, healthcare organization, merchant or some other party) that wishes to process a transaction with the user 101. The service provider server 107, for example, has a website on which the user wishes to execute a transaction. In some embodiments, the service provider server provides a physical good, digital good, or service in return for a successful transaction with the user. In other cases, the service provider provides access to data, writes data, edits data, sends a command, etc. More generally, the service provider executes an action being requested by an interested party (e.g., service provider, user, etc.)

The ID Server 108 executes processes that establish and attests to the identity of a user. For purpose of establishing identity, for example, the ID Server verifies the identity of the user against a trusted government credential using facial biometrics. For purposes of attestation, the ID Server executes the FIDO protocol to store registered and authenticated user accounts. The ID Server performs Strong Identity using facial biometric data from a live captured image of a user against either a reference image or a cropped image of a credential with methods described in the different embodiments. The ID Server attests to the authentication of a user by sending a challenge to the user device of the user, receiving a response to the challenge that is signed by the device authenticator 105 of the user device, and authenticating the response using the FIDO protocol. For new users, the ID Server also executes a registration process that includes verifying facial biometric data.

In the examples provided herein, an initial condition is already established that includes a device authentication private key being securely stored on the device authenticator 105, and the corresponding device authentication public key being stored on the ID Server 108. The generation and storage of these keys, for example, adhere to the FIDO protocols developed by the FIDO Alliance (www.fidoalliance.com). In an example aspect, the device authenticator generates the device authenticator private key and the device authenticator public key, and the device authenticator sends the device authenticator public key to the ID Server 108 for storage. The device authentication private key can be used to sign responses. These signed responses can include other data, depending on the application. For example, signed responses can include credential data, authorization data, commands, transaction details, etc.

The trusted verifier server 109, also called the TVS, executes processes to verify an identity document. The TVS 109 for example is specific to a certain organization depending on the type of identity document. For example, a government entity may have a TVS 109 that verifies a government issued identity document (e.g., a passport). A DMV entity, for example, has a TVS 109 that verifies driver licenses, which are a type of identity document. A credit check organization, for example, has a TVS that verifies credit card identity documents. A healthcare entity, for example, has a TVS 109 that verifies healthcare identity documents. The TVS 109, for example, is in data communication with one or more of the other servers 107, 108 and verifies the identity document associated with a user.

The term “identity document” herein refers to a document that includes identity information or credential information, or both, about a user. In an example embodiment, the identity document includes a photograph of the user. Other types of information that an identity document could include are, for example: name, address, data of birth, sex, citizenship, weight, height, signature, serial number, issue date, expiry date, a code, a bar code, a QR code, special markings (e.g., water markings, holographic markings, stamps, insignia, etc.), a signature of a user, data related to a user account, credentials of the user, data related to the organization, etc. Examples of identity documents include: a driver license, a passport, a healthcare card, a student card, a citizenship or national identity card, an employee card, an academic certificate, a government document, and a health report. Other types of identity documents can be used according to the principles described herein.

It will be appreciated that there may be multiple instances of each of the servers. For example, different instances of a server store different data, or are located in different geographical regions, or both.

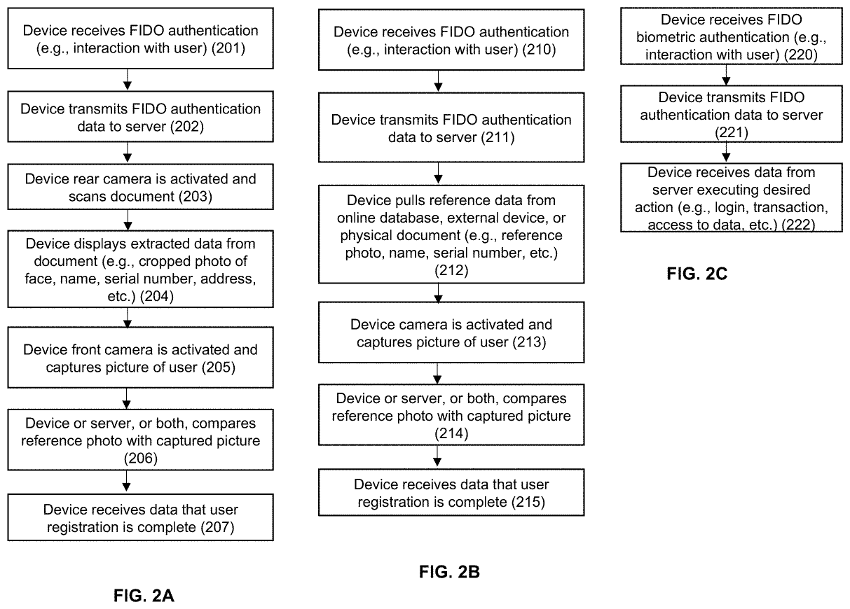

Turning to FIG. 2A, example executable instructions are provided for registering a user using facial scanning.

Block 201: The user device receives FIDO authentication through an interaction with the user. For example, the FIDO authentication includes biometric authentication and a scanner device 106 scans one or more biometric features of the user. In an example embodiment, the user places his or her finger on a fingerprint scanner (e.g., thumbprint or other finger) as part of the authentication. In another example, the user device includes a facial scanner to scan the user's face. It will be appreciated that other types of FIDO authentication methods and devices can be used.

Block 202: After the FIDO authentication is complete (block 201), the user device transmits the FIDO authentication data to the ID Server 108. This data is signed by the DA private key.

Block 203: The user device's camera is activated and scans the identity document. For example, the user agent 104 automatically activates the rear camera 106a and the user 101 captures a digital image of the identity document.

Block 204: The user device displays, on its display screen, extracted data from the identity document. The data extracted from the display screen includes one or more of: a cropped photo of a face, the name, serial number, address, credentials, etc.

Block 205: The user device's camera is activated and captures a picture of the user's face. For example, the user agent 104 automatically activates the front camera 106b and the user 101 captures a digital image of himself or herself (e.g., also called a “selfie” photo or picture).

Block 206: The user device automatically digitally compares the cropped photo from the identity document with the captured picture (e.g., the selfie) to see if the faces match. This comparison can be digitally executed using a face matching algorithm. Currently known and future-known digital computations for face recognition and face matching algorithms can be used. Non-limiting examples of currently known face recognition or face matching algorithms include: Eigenfaces; Convolutional Neural Networks (CNNs); model-based face recognition; feature-based face recognition; and hybrid methods that include detection, position, representation, and matching. In an example embodiment, the user device executes the digital comparison locally on the user device's processor hardware. In another example embodiment, the user device initiates the comparison and transmits the image data to the ID Server 108 to execute the face matching algorithm.

It will be appreciated that after the ID Server receives the verification data associated with the scanned document and the selfie picture, as well as the FIDO authentication data, the ID Server completes the registration of the user (e.g., their user account is registered). The face matching comparison using the face (e.g., pixels of the face of the digital image) from the identity document and the face (e.g., pixels of the face of the digital image) from the selfie picture must provide a result indicating a match for the registration to be complete. If the faces from the two digital image files of the identity document and the selfie picture are not considered a match, then the registration remains incomplete.

Block 207: The user device then receives data from the ID Server 108 that the user registration is complete. In other words, the FIDO authentication and the face matching were successfully completed.

In the example of FIG. 2A, the operations of blocks 203, 204, 205 and 206 is also herein referred to as “identity binding”. The identity binding process could take place at a different or later session after the FIDO authentication.

In an example aspect of FIG. 2A, the order and timing of when the FIDO authentication data is obtained and when the verification data related to the scanned document and self ie picture can be reversed, implemented at separate times, etc. For example, in an alternative embodiment, blocks 203, 204, 205 and 206 take place first, and then blocks 201 and 202.

It will be appreciated that if the FIDO authentication fails or if the verification of the scanned document or the user's photo fail, then the registration is not completed.

In another example aspect, the ID Server compares the selfie picture of the user, which was captured by the device's camera, with a photograph from a trusted database.

In another example aspect, the user device's camera additionally captures a picture of other parts of the scanned document (e.g., backside, other pages, etc.) to capture more data, which is compared to data on a trusted database.

In another example aspect, the user device includes a Near-Field Communication (NFC) scanner and the scanned document includes a NFC readable module. For example, the scanned document is a credential card or user account card with a NFC readable module that stores data. The user device NFC taps or scans the scanned document to read the stored data in the NFC module, and the user device transmits this stored data to the ID Server for verification as part of the identity binding process.

Turning to FIG. 2B, another example embodiment is provided for registering a user, which is similar to the process of FIG. 2A. However, the data used for identity binding is not limited to a taking a picture of a scanned document that includes a photo of a user.

Block 210: The user device receives FIDO authentication through an interaction with the user. For example, the FIDO authentication includes biometric authentication and a scanner device 106 scans one or more biometric features of the user.

Block 211: After the FIDO authentication is complete, the user device transmits the FIDO authentication data to the ID Server 108. This data is signed by the DA private key.

Block 212: The user device pulls reference data from one or more online databases, or from an external device, or from a NFC module, or from a physical document, or a combination thereof. The reference data, for example, includes a reference photo of the user, a name, a serial code, etc. The reference data, for example, can be obtained by accessing databases, establishing communication with an external device, scanning a NFC module, scanning a physical document, etc.

In an example aspect, the user device initiates the pulling of the reference data, but does not actually store or access the reference data.

Block 213: The user device activates a camera and captures a picture of the user (e.g., a selfie photo or picture).

Block 214: The user device compares the reference photo (from the reference data) with the captured picture (e.g., the self ie) to see if the faces match. This comparison can be executed using a face matching algorithm. In an example embodiment, the user device executes the comparison locally on the user device. In another example embodiment, the user device initiates the comparison and transmits the image data to the ID Server 108 to execute the face matching algorithm.

It will be appreciated that after the ID Server receives the verification data associated with the reference data and the selfie picture, as well as the FIDO authentication data, the ID Server completes the registration of the user (e.g., their user account is registered).

Block 215: The user device then receives data from the ID Server 108 that the user registration is complete.

Turning to FIG. 2C, example executable instructions are provided for authenticating with the user agent after the user has been registered.

Block 220: The user device receives FIDO authentication through an interaction with the user. For example, the FIDO authentication includes biometric authentication and a scanner device 106 scans one or more biometric features of the user (e.g., thumbprint, fingerprint, facial scan, etc.).

Block 221: Assuming the FIDO authentication is successful, the user device transmits the FIDO authentication data to the ID Server 108. This data is signed by the DA private key.

Block 222: The user device receives data from the ID Server 108, which is used to execute the desired action (e.g., logging in, performing a transaction, accessing data, etc.).

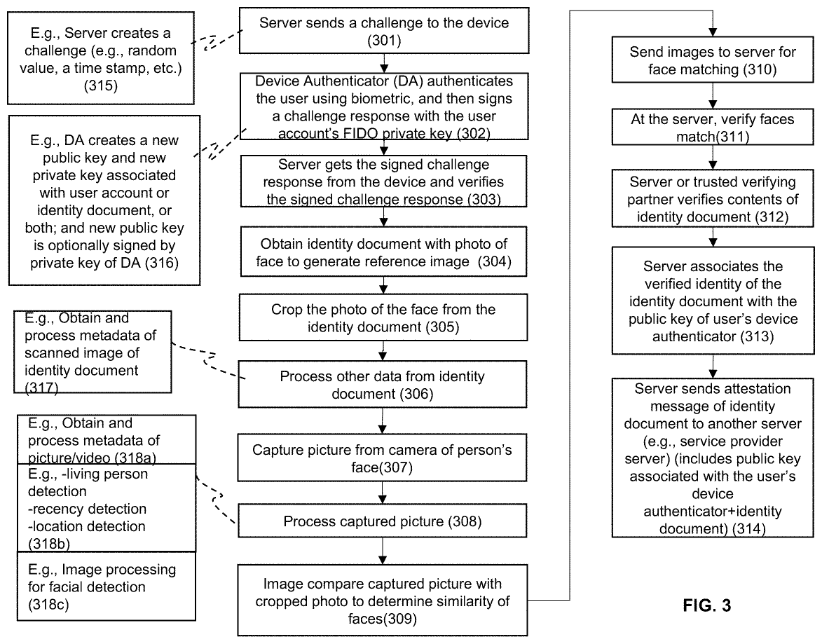

A more detailed process of the registration is shown in FIG. 3.

Block 301: The ID Server 108 sends a challenge to the user device.

In an example aspect, the ID Server creates a challenge. For example, it computes hash of one or more of a nonce, a timestamp, etc. The challenge, for example, is signed by the ID Server's private key (block 315). It is appreciated that the ID Server's public key is transmitted to the user device at the same time as sending the challenge to the user device, or at some time prior to sending the challenge. In this way, the user device can use the ID Server's public key to verify the ID Server's signature of the challenge.

Block 302: The user device receives the challenge. The device authenticator (DA) 105 authenticates the user using FIDO authentication process. For example, the user provides thumbprint or fingerprint authentication, or facial scan, or some other form of authentication (not limited to biometric authentication). If the FIDO authentication process is successfully completed, then the device authenticator 105 signs the challenge response.

In an example aspect of block 302, the device authenticator 105 creates a new public key and new private key associated with the user account to be registered, or the identity document, or both. In a further example aspect, the new public key is associated with both the user account to be registered or the identity document (or both), as well as the device authenticator. This new public key is optionally signed by the device authenticator's private key (block 316). The challenge response is signed by the device authenticator using the new private key. The challenge response also includes the new public key. It will be appreciated that this new private key that is associated with the user account to be registered or the identity document (or both) is stored on the user device (e.g., on the device authenticator).

In another example aspect, of block 302, the user device verifies the contents of the challenge.

Block 303: The ID Server 108 receives the signed challenge response from the user device and verifies the signed challenge response. For example, the ID Server 108 uses the public key that is associated with the user account or the identity document (or both) to verify the signature of the challenge response.

Block 304: The user device obtains an identity document that includes a digital photo of the user's face to extract a reference image. In an example aspect, the user device scans the identity document using a camera or some other type of scanner to generate a scanned image (e.g., an array of pixels forming a digital image of the identity document). In another example aspect, the reference image is obtained from accessing an online database, or from accessing another device, or scanning a NFC module, or some other process.

Block 305: The user device automatically crops the photo of the face from the scanned image of the identity document. The cropped photo of the face is a subset of the pixels extracted or derived from the pixels of the digital image of the identity document. For example, edge detection can be used to automatically detect the pixels that from the photo of the face. Other image recognition or pattern recognition approaches to isolate the reference image, if it requires isolation, can be used.

Block 306: The user device processes other data from the identity document.

In an example aspect of block 306, the use device, or a server, extracts other data from the scanned image of the identity document. For example, this text data is extracted using optical character recognition or text recognition, or both. Examples of the other extracted data include text data, insignia, graphics, numeric data, position of text data and graphics on the document, barcode, QR code, etc. In addition or in alternative, the data extracted from the identity document is scanned using NFC, or by accessing a database, or by accessing another device, or a combination thereof.

In another example aspect of block 306, the user device also obtains and processes metadata of a scanned image of the identity document (block 317). Meta data includes, for example, time stamp, geolocation tagging, user device information, and camera information (e.g., F-stop, ISO, focal length, etc.) associated with the scanned image of the identity document. This metadata can be used for verification.

Block 307: The user device captures a digital picture from a camera of the person's face. This is also called a selfie. The picture is a digital data file that includes an array of pixels, amongst other things, and that includes image data of the person's face. The picture, in other words, can include one or more images. In an example aspect, this captured picture is a single static image. In another example aspect, the captured picture is a series of static images. In another example aspect, the captured picture is extracted from a video file. In another example aspect, the captured picture is a digital video file.

Block 308: The user device processes this captured digital picture.

In an example aspect of block 308, the user device obtains and processes metadata of the picture (block 318a). Examples of metadata associated with the digital picture include: time stamp, geolocation tagging, user device information, and camera information associated with the captured picture of the user.

In another example aspect of block 306, the user device uses executes one or more processes to determine if the person is using a live picture, as opposed to submitting a pre-recorded video or using an earlier captured image. Examples of these processes include: living person detection, recency detection and location detection, which can be used alone or in combination (block 318b). For example, the user device executes a living person detection process which analyses a series of image frames to look at movement in the face (e.g., blinking, eye movement, mouth movement, head movement, etc.). These changes of facial features are used by tracking these features over a series of image frames, such as taken in a video or a succession of snapshot images. In another example of living person detection, the user device, or a wearable device in data communication with the user device, measures heartrate, breathing, etc. to detect the person is alive. In the recency detection process, the user device analyses the time stamp of the captured picture of the face to see if it was just taken (as opposed to an older image). Furthermore, the recency detection process can also compare the time stamp of the scanned image of the identity document with the time stamp of the captured picture of the user's face. If the time stamps are within a threshold time period (e.g., less than x minutes), then the images are considered recent. In the location detection process, the user device analyses the geolocation tag of the captured picture with the geolocation tag of the scanned image of the identity document and determine whether they are in the same general location. If so, then user device confirms, or increases a confidence value, that the user does hold the actual identity document and has just captured a picture of himself or herself (e.g., the selfie). Another detection process includes detecting if the same user device was used to capture the scanned image of the identity document and the selfie. If so, this helps confirm that the user holds the actual identity document and has just captured the selfie. If these detection processes detect inconsistencies or that the person in the selfie is not alive (e.g., it is a photo of a photo), then the registration process is stopped.

In another example aspect of block 308, image processing is executed on the captured picture for facial detection (block 318c). This can include executing edge detection, modifying image settings, etc.

In an example aspect, the processes described in relation to blocks 308, 318a, 318b, 318c can be implemented by the ID Server 108 or a partner server in communication with the ID Server.

Block 309: The user device, or the ID Server on instruction on the user device (blocks 310, 311), digitally compares the captured picture (e.g., the self ie) with the cropped photo from the scanned image of the identity document to determine similarity of faces. The user device or the server verifies that the faces match each other. In particular, digital computations for face matching or face recognition, which are executed by the processor of the user device or by the processor of the ID Server, or both, are used to determine if there is a match in the faces from the digital images.

It will be appreciated that if the server or the user device determine that the faces do not match, then the registration process is stopped.

Block 312: In an example aspect, for additional verification of the identity document, the ID Server 108 or a trusted verifying partner (e.g., the TVS 109) verifies contents of identity document. For example, the ID Server extracts text data (e.g., using optical character recognition) and other data from the scanned image of the identity document. For example, if the identity document is a driver license, then the extracted text data from the scanned image is sent to the TVS 109 for verification of the name, address, driver license number, issue date, expiry date, etc. The TVS 109 verifies that this information is correct and sends a verification message back to the ID Server indicating the same.

If the information extracted from the identity document is found to be unverified (e.g., a fake driver's license, a fake passport, a fake credential document, etc.), then the registration process is stopped.

Block 313: The ID Server associates the verified identity document with the public key associated with the user account or the identity document (or both). More generally, the ID Server associates the verified identity document with the public key associated with the user's device authenticator.

Block 314: The ID Server sends an attestation message of the identity document to another server (e.g., service provider server 107). In an example aspect, the attestation message includes the public key that is associated with the identity document and the user's device authenticator.

In an example aspect, the ID Server 108 has associated with it a private key, called the LID private key, and a corresponding LID public key. The service provider server 107 has a copy of the LID public key. When generating the attestation message, the ID Server signs the attestation message using the LID private key. The service provider server 107 uses the LID public key to verify that the attestation message has been signed by the ID Server.

Alternatively, the ID Server uses its ID Server private key to sign the public key that is associated with the identity document, which becomes an ID Server signature. In this way, the device authenticator's signature associated with the identity document is attested to by the ID Server 108.

The user, via their user device, is now registered with the ID Server and, where applicable, one or more corresponding service provider servers.

It will be appreciated that the order of operations for capturing a picture of the user's face and obtaining an identity document (e.g., scanning the identity document with the camera) can vary. For example, the self ie picture is captured first and then the identity document is scanned. Alternatively, for example, the order is reversed.

In an example embodiment, the FIDO authentication process and the facial identification process are performed in a single data session (e.g., a single data connection) between the ID Server and the user device. In a single data session, the user device completes the processes before disconnecting from the ID Server. In another example embodiment, the FIDO authentication process and the facial identification process are performed across separate data sessions (e.g., two or more different data connections) between the ID Server and the user device. In separate data sessions, for example, the user device connects to the ID Server to start a first data session; disconnects from the ID server to end the first data session; reconnects to the ID Server to start a second data session; and disconnects from the ID Server to end the second data session.

In another example aspect, the FIDO authentication process is executed in one data session between a first subset of server(s) of the ID Server and the user device; and the facial identification process is executed in a different data session between a second subset of server(s) of the ID Server and the user device. In this particular example aspect, the ID Server includes different subsets of servers that are in data communication with each other, including a first subset of one or more servers that execute the FIDO authentication process, and further including a second subset of one or more servers that execute the facial identification process.

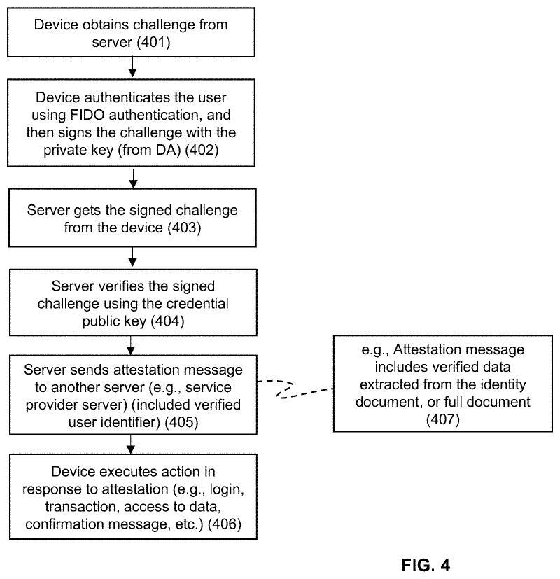

Turning to FIG. 4, an example embodiment of a follow-up action is shown after the registration is complete. In other words, after the registration, the user can use the user agent 103 to perform actions (e.g., logging in, access data, modify data, execute a command, perform a transaction, etc.).

After registration, it will be appreciated that the initial conditions include the ID Server 108 storing the public key associated with the identity document and the device authenticator, and the user device storing the corresponding private key. In an example aspect, the ID Server stores the scanned image of the identity document, or stores the extracted data from the identity document. In an alternative example aspect, the ID Server does not store the scanned image of the identity document and does not store the extracted data from the identity document, but instead stores a representation of the identity document (e.g., a unique ID associated with the identity document).

Block 401: The user device obtains a challenge from the ID Server 108.

Block 402: The user device authenticates the user using FIDO authentication, and then signs the challenge with the corresponding private key. The private key, for example, is stored on the device authenticator. In an example aspect, the FIDO authentication includes the user interacting with a scanner (e.g., thumbprint scanner, face scanner, etc.).

Block 403: The ID Server receives gets the signed challenge from the device

Block 404: The ID Server verifies the signed challenge using the public key associated with the identity document and the device authenticator.

Block 405: The ID Server sends an attestation message to another server (e.g., service provider server 107). In an example aspect, the attestation message includes a verified user identifier.

In an example aspect, the attestation message includes verified data extracted from the identity document, or the full document (block 407). The data, for example, includes personal identifying information (PII).

Block 406: The user device executes an action in response to the attestation. For example, the action in one or more of: logging in to an account, accessing data, providing confirmation, executing a transaction, etc.

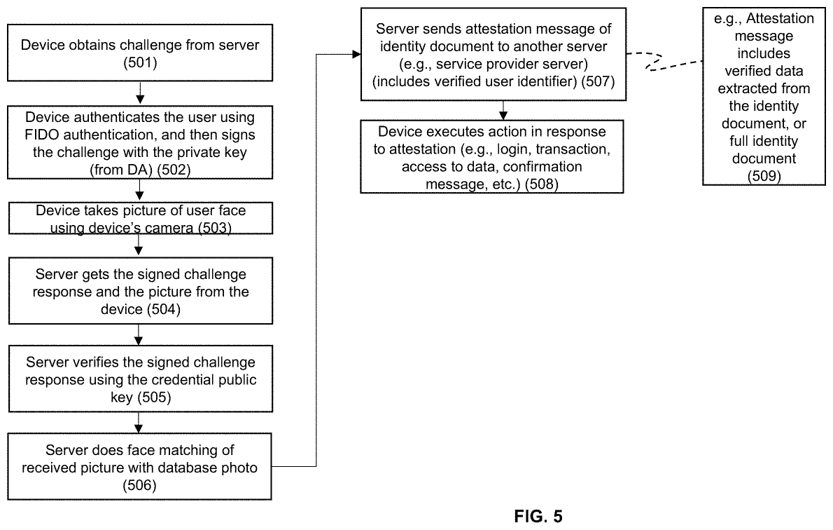

Turning to FIG. 5, an example embodiment of another follow-up process is shown after registration, which is in alternative to the process of FIG. 4. The initial conditions after registration includes the same initial conditions described with respect to FIG. 4.

Block 501: The user obtains a challenge from ID Server 108.

Block 502: The user device authenticates the user using FIDO authentication (e.g., scanning a thumbprint, face, RFID tag, etc.), and then signs the challenge with the private key associated with the identity document and the device authenticator.

Block 503: The user device takes picture of the user's face using the user device's camera.

Block 504: The ID Server then receives the signed challenge response and the picture from the user device.

Block 505: The ID Server verifies the signed challenge response using the public key associated the identity document and the device authenticator. The public key corresponds to the private key used at block 502.

Block 506: The ID Server executes face matching computation of the received picture and one or more stored photos of the user. For example, a stored photo of the user was obtained during the registration process. The one or more stored photos, for example, include the photo extracted or cropped from the scanned image the identity document, or the selfie picture submitted during registration, or both. If the face from the received picture does not match the one more stored photos, then the follow-up authentication process is stopped. Otherwise, if the match is confirmed, then the follow-up authentication process continues.

Block 507: The ID Server sends an attestation message of the identity of the user (e.g., attesting identity document, identity of the user, or data extracted from the identity document) to another server (e.g., service provider server 107). In an example aspect, the attestation message includes the verified user identifier.

In an example aspect, the attestation message includes one or more of: verified data extracted from the identity document; at least part of identity document; and a face image of the user (block 509).

Block 508: The user device executes an action in response to the attestation (e.g., login, transaction, access to data, confirmation message, etc.)

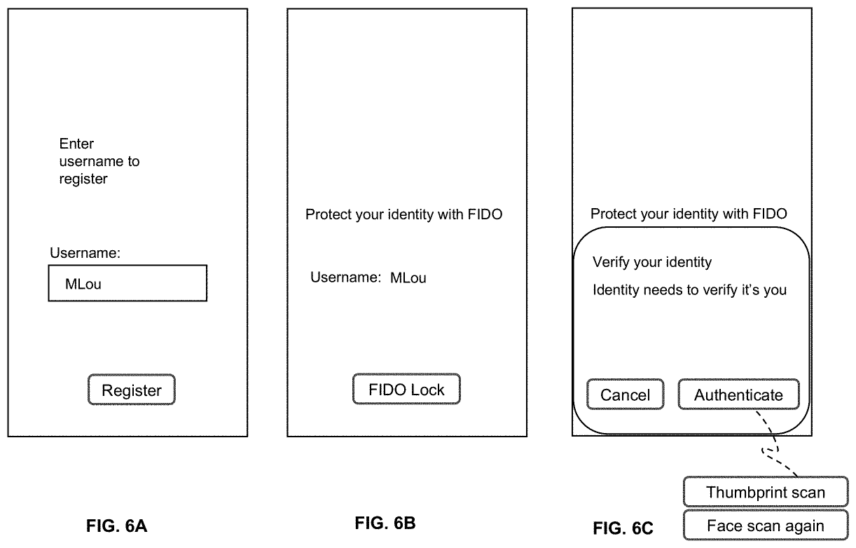

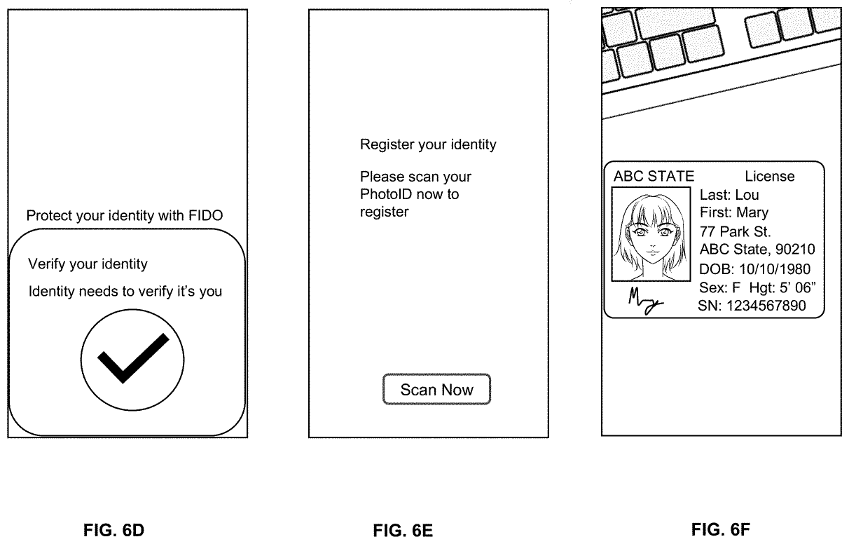

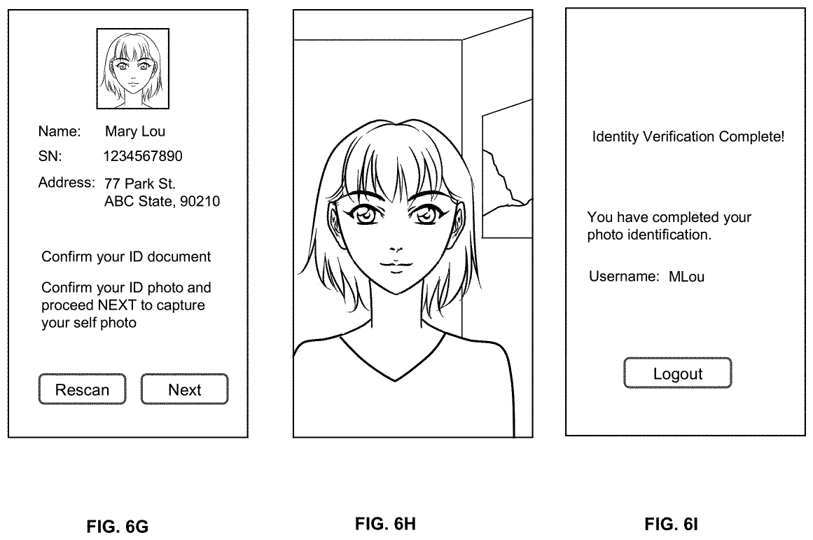

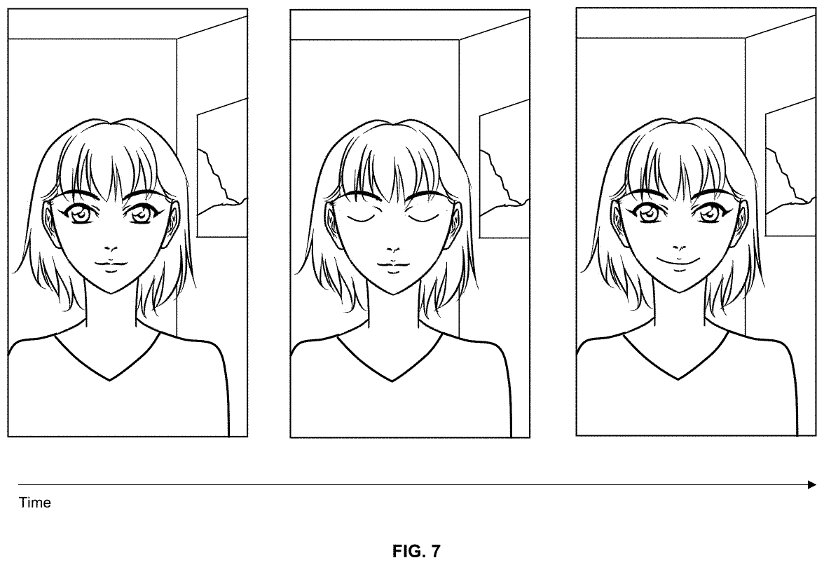

Turning to FIGS. 6A to 6I, an example graphical user interface (GUI) is shown for registration using facial scanning. The GUI is displayable by the user device's display screen and uses one or more cameras. In an example embodiment, the GUI is part of the user agent 104 (e.g., an app or a web browser).

In FIG. 6A, a screenshot of a GUI is shown that includes a text box for receiving user input of the username. The GUI receives an input on a “register” button, and proceeds with the registration process.

In FIG. 6B, the GUI shows a screen that shows a button “FIDO Lock”, to further establish and protect the identity using FIDO authentication. The user device detects that a user selection on this button.

In FIG. 6C, the GUI then displays a message to initiate FIDO authentication, or to cancel the FIDO authentication process. The message, for example, includes the word “Authenticate”, but other messages could include thumbprint scan, or face scan again. In other words, the use can press their thumb or finger to a scanner, or perform a face scan.

If the scanned data verifies the user, then an indicator is shown in FIG. 6D, such as a checkmark, or text indicating verified, success, etc.

The GUI, in FIG. 6E, then shows a message to the user to scan their photolD (e.g., a type of identity document) to register the user. For example, the photo ID is a driver's license, a passport, etc. The GUI then receives an input on the “scan now” button.

The GUI, in FIG. 6F, then activates a camera on the user device to take a picture of the photolD. For example, the rear camera is activated and the user positions their user device to have the driver license in the camera's field of view. The user device then captures a picture of the driver license (e.g., the scanned image of the identity document).

The GUI, in FIG. 6G, then shows a cropped photo of the user's face that is extracted from the driver license using image processing. The GUI in FIG. 6G also shows other extracted information, such as name, serial number and address. For example, this information is extracted by executing optical character recognition on the image of the driver license. If the user selects the “rescan” button, then the camera is reactivated and the GUI in FIG. 6F is shown. If the user selects the “next” button, the GUI in FIG. 6E is shown.

In FIG. 6H, the camera is activated on the user device to take a selfie of the user. For example, the front facing camera is activated and a picture of the user's face is captured. The picture of the user's face (e.g., the selfie) and the cropped photo from the driver license are digitally compared. If the results of the digital comparison produce a match, the process proceeds to the GUI in FIG. 6I.

In FIG. 6I, the message on the GUI shows that the identity verification is complete, and that the user has completed their photo dentification. The user can choose to logout of the user agent.

In an example embodiment of FIG. 6H, a series of digital images are captured by the user device of the person for living person detection. For example, turning to FIG. 7, multiple images are captured one after another of the person. In first captured image, the user's eyes are open and the mouth is in a neutral position. In the second captured image, the user's eyes are closed (e.g., blinking) and the mouth is in a neutral position. In the third captured image, the user's eyes are open again and the mouth is in a smile position. These images may be part of a video, or are part of a series of static images. Using digital image processing, the user's change or movement of facial parts (e.g., movement of eyes, movement of mouth, movement of eye brows, movement of ears, movement of hair, etc.) is detected over a series of consecutive images. If there is change or movement of the user's facial parts detected over the series of consecutive images, then the user device or the server determines that a live person is present. If there is no change or movement of the user's facial parts that is detected over the series of consecutive images, then the user device or the server determines that there is no live person. For example, a bad actor attempted to use a still image of the person to fraudulently complete authentication. It will be appreciated that there are other ways to measure or detect whether a person is alive when they are using the user agent 104 for registration.

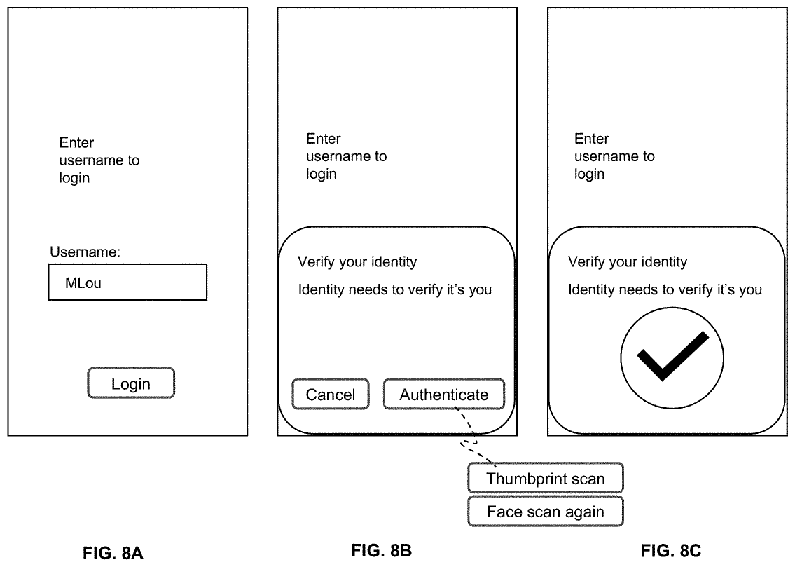

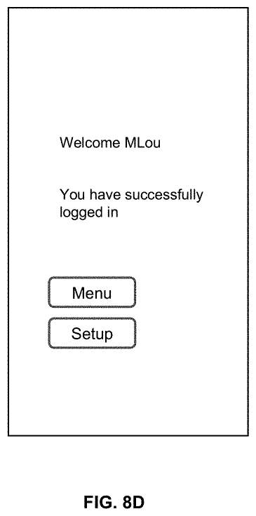

After registration is complete, the example screenshots of the GUI are shown in FIGS. 8A to 8D.

FIG. 8A shows a login screen to enter a username. Alternatively, the username is already stored and the user simply selects the “login” button.

FIG. 8B shows a verification message requesting the user to verify themselves. The user can select the button “authenticate” or some other button or action, such as a thumbprint scan, a face scan, an RFID scan, etc. In other words, the scanner is used to scan the person or something as part of the FIDO authentication process.

After the FIDO authentication is successful, in FIG. 8C, the GUI shows an indication message showing the same.

In FIG. 8D, the GUI then shows a welcome message indicating their successful log in. The user can then proceed to perform their desired action.

The user device and the ID Server can use this digital facial scanning for strong identity and strong authentication in various applications. For example, an organization (e.g., government entity, bank, business, education institution, etc.) wants to satisfy KYC (know your client) requirements and ensure that their client is who they say they are. The organization can then verify and authenticate a user using the devices and processes described herein, thereby satisfying KYC requirements.

In another example, a driver is required to verify himself or herself before driving a car (e.g., a shared resource). To do so, the driver uses their user device to verify their identity using their driver license, and associates the verified identity with FIDO authentication. At later instances, such as when the driver wants to drive the car, or at some other driving condition, the driver authenticates himself using FIDO authentication. This FIDO authentication is associated with the verified identity bound to the driver license. In this way, the ID Server 108 grants access or sends a command that permits the driver to drive the car, or indicates approval for the driver to drive the car.

In another example, a person is required to verify himself or herself to a government to obtain approval for travel or entry using a passport. To do so, the person uses their user device to verify their identity using their passport, and associates the passport with FIDO authentication. At later instances, such as when the person needs to provide a passport verification or check, the person authenticates himself using FIDO authentication. This FIDO authentication is associated with the verified identity bound to the passport. In this way, the ID Server 108 sends a command that permits the person through a check point, or indicates approval for the person to travel or have entry.

Below are general example embodiments and example aspects.

In an example embodiment, a user device is provided comprising: a camera system, a processor, a communication module, memory, and a display. The processor executes instructions to at least: initiate a FIDO authentication of the user; activate the camera system to capture a scanned image of an identity document that includes a photo of a user; activate the camera system to capture a picture of a face of the user; initiate a digital image comparison of the photo of the user from the scanned image of the identity document with the captured picture of the face of the user; and transmit, via the communication module, verification data associated with the identity document and FIDO authentication data.

In an example aspect, the communication module receives data indicating a desired action is complete.

In another example aspect, the user device further comprises a device authenticator, and the device authenticator executes instructions to at least create a public key associated with a user account and a corresponding private key, wherein the user account is associated with data derived from the identity document, the private key is stored in the device authenticator and the public key is part of the FIDO authentication data.

In another example aspect, the user device further comprises a biometric scanner, wherein the FIDO authentication comprises receiving biometric data from the user.

In another example aspect, the processor further executes instructions to at least crop the photo of the user from the scanned image of the identity document.

In another example aspect, the processor further executes instructions to at least extract text data or numeric data, or both, from the scanned image of the identity document using optical character recognition, and the extracted text data or numeric data, or both, is part of the verification data associated with the identity document.

In another example aspect, the camera system comprises a front camera and a rear camera, and the processor activates the rear camera to capture the scanned image of the identity document, and processor activates the front camera to capture the picture of the face of the user.

In another example aspect, the processor further executes instructions to at least initiate a living person detection process when capturing the picture of the face of the user.

In another example aspect, the living person detection process comprises capturing a series of image frames of the face of the user and detecting movement of one or more facial features.

In another example aspect, after the user device transmits the verification data associated with the identity document, the user device receives a challenge via the communication module. The processor executes the FIDO authentication to sign a challenge response using a private key associated with the identity document, the private key corresponding to a public key also associated with the identity document, both created by the user device, and the public key is part of the FIDO authentication data.

In another example aspect, the user device further comprises a device authenticator, which creates the private key and the public key associated with the identity document, and stores the private key that is associated with the identity document.

In another example aspect, the device authenticator comprises a device authenticator private key, and the public key associated with the identity document is signed by the device authenticator private key.

In another example aspect, the desired action is a user registration.

In another example aspect, the identity document is a trusted identity document, such as a driver license or a passport.

In another example aspect, the user device forms a single data session with a server to complete the FIDO authentication and a verification process that uses the identity document and the photo of the user.

In an example embodiment, a server is provided comprising: a communication module, a processor, and memory. The communication module obtains at least a scanned image of an identity document that comprises a photo of a person. The processor executes instructions to at least: generate a challenge; transmit the challenge; receive a signed challenge response that comprises a public key associated with a user account, and the user account is associated with the identity document; and, after verifying the signed challenge response, store the public key with the scanned image of the identity document or identifying data of the identity document.

In an example aspect, the communication module further obtains an image of the person's face, and the processor initiates a digital comparison of the image of the person's face and the photo of the person from the scanned image of the identity document, and, after verifying a match of facial features, transmitting the challenge.

In another example aspect, the processor further executes instructions to at least obtain extracted text data or numeric data, or both, from the scanned image of the identity document, and verifies the extracted text data or number data, or both, with a trusted verified data source.

In another example aspect, the communication module establishes a communication session with a user device, and wherein: the scanned image is transmittable from the user device, the challenge is transmittable to the user device, and the signed challenge response is transmittable from the user device.

In another example aspect, the public key that is associated with the identity document corresponds to a private key also associated with the identity document, and the private key is storable on the user device.

In another example aspect, the processor further executes instructions to at least generate and send an attestation message that comprises a verified user identity of the user.

In another example aspect, the server forms a single data session with a user device of the person to complete a FIDO authentication of the person and to complete a facial identification using the identity document and the photo of the person.

In an example embodiment, a non-transitory computer readable medium is provided that comprises program instructions stored therein that are executable by a user device to perform operations comprising: initiating a strong authentication of the user; activating the camera system to capture a scanned image of an identity document that includes a photo of a user; activating the camera system to capture a picture of a face of the user; initiating a digital image comparison of the photo of the user from the scanned image of the identity document with the captured picture of the face of the user; and transmitting, via the communication module, verification data associated with the identity document and strong authentication data.

In an example embodiment, a non-transitory computer readable medium is provided that comprises program instructions stored therein that are executable by a server to perform operations comprising: obtaining via a communication module at least a scanned image or extracted data of an identity document that comprises a photo of a person; generating a challenge; transmitting the challenge; receiving a signed challenge response that comprises a public key associated with a user account, and the user account is associated with the identity document; and, after verifying the signed challenge response, storing the public key with the scanned image or extracted data of the identity document or identifying data of the identity document.

It will be appreciated that any module or component exemplified herein that executes instructions may include or otherwise have access to non-transitory computer readable media such as storage media, computer storage media, or data storage devices (removable and/or non-removable) such as, for example, memory chips, magnetic disks, optical disks. Computer storage media may include volatile and non-volatile, removable and non-removable media implemented in any method or technology for storage of information, such as computer readable instructions, code, processor executable instructions, data structures, program modules, or other data. Examples of computer storage media include random access memory (RAM), dynamic random access memory (DRAM), static random access memory (SRAM), read-only memory (ROM), solid-state ROM, electrically erasable programmable read-only memory (EEPROM), flash memory or other memory technology, or any other medium which can be used to store the desired information and which can be accessed by an application, module, or both. Any such computer storage media may be part of the servers or computing devices, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

The elements and screenshots of the GUIs shown herein are just for example. There may be many variations to these GUI elements or operations according to the principles described herein. For instance, the GUI elements and operations may be performed in a differing order, or GUI elements or operations may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A user device comprising:
a camera system, a processor, a communication module, a memory module, and a display; and
the processor is configured to execute instructions stored in the memory module to at least: initiate a strong authentication of the user; activate the camera system to capture a scanned image of an identity document that includes a photo of a user; activate the camera system to capture a picture of a face of the user; initiate a digital image comparison of the photo of the user from the scanned image of the identity document with the captured picture of the face of the user; and transmit, via the communication module, verification data associated with the identity document and strong authentication data.

2. The user device of claim 1 wherein the communication module receives data indicating a desired action is complete.

3. The user device of claim 1 further comprising a device authenticator, and the device authenticator executes instructions to at least create a public key associated with a user account and a corresponding private key, wherein the user account is associated with data derived from the identity document, the private key is stored in the device authenticator and the public key is part of the strong authentication data.

4. The user device of claim 1 further comprising a biometric scanner, wherein the strong authentication comprises receiving biometric data from the user.

5. The user device of claim 1 wherein the strong authentication is Fast Identity Online (FIDO) authentication.

6. The user device of claim 1, wherein the processor further executes instructions to at least crop the photo of the user from the scanned image of the identity document.

7. The user device of claim 1, wherein the processor further executes instructions to at least extract text data or numeric data, or both, from the scanned image of the identity document using optical character recognition or Near Field Communication (NFC), and the extracted text data or numeric data, or both, is part of the verification data associated with the identity document.

8. The user device of claim 1 wherein the camera system comprises a front camera and a rear camera, and the processor activates the rear camera to capture the scanned image of the identity document, and processor activates the front camera to capture the picture of the face of the user.

9. The user device of claim 1 wherein the processor further executes instructions to at least initiate a living person detection process when capturing the picture of the face of the user.

10. The user device of claim 9 wherein the living person detection process comprises capturing a series of image frames of the face of the user and detecting movement of one or more facial features, as well as performing presentation attack detection to protect against spoofing techniques.

11. The user device of claim 1, wherein after the user device transmits the verification data associated with the identity document, the user device receives a challenge via the communication module; and wherein the processor executes the strong authentication to sign a challenge response using a private key associated with the identity document, the private key corresponding to a public key also associated with the identity document, both created by the user device, and the public key is part of the strong authentication data.

12. The user device of claim 11 further comprising a device authenticator, which creates the private key and the public key associated with the identity document, and stores the private key that is associated with the identity document.

13. The user device of claim 12 wherein the device authenticator comprises a device authenticator private key, and the public key associated with the identity document is signed by the device authenticator private key.

14. The user device of claim 1 wherein the desired action is a user registration.

15. The user device of claim 1 wherein the identity document is a trusted identity credential.

16. The user device of claim 1 wherein the user device forms a single data session with a server to complete a strong identity process and the strong authentication process that use the identity document and the photo of the user.

17. A server comprising:
a communication module, a processor, and memory;
the communication module obtains at least a scanned image or extracted data of an identity document that comprises a photo of a person;
the processor executes instructions to at least: generate a challenge; transmit the challenge; receive a signed challenge response that comprises a public key associated with a user account, and the user account is associated with the identity document; and, after verifying the signed challenge response, store the public key with the scanned image or extracted data of the identity document or identifying data of the identity document.

18. The server of claim 17 wherein the communication module further obtains an image of the person's face, and the processor initiates a digital comparison of the image of the person's face and the photo of the person from the scanned image of the identity document, and, after verifying a match of facial features, transmitting the challenge.

19. The server of claim 17 wherein the processor further executes instructions to at least obtain extracted text data or numeric data, or both, from the identity document, and verifies the extracted text data or number data, or both, with a trusted verified data source.

20. The server of claim 17 wherein the communication module establishes a communication session with a user device, and wherein: the scanned image or extracted data is transmittable from the user device, the challenge is transmittable to the user device, and the signed challenge response is transmittable from the user device.

21. The server of claim 17 wherein the public key that is associated with the identity document corresponds to a private key also associated with the identity document, and the private key is storable on the user device.

22. The server of claim 17 wherein the processor further executes instructions to at least generate and send an attestation message that comprises a verified user identity of the user.

23. The server of claim 17 wherein the server forms a single data session with a user device of the person to complete Strong Identity and Strong Authentication processes that use the identity document, the live photo of the user and facial biometrics.

24. The server of claim 17 wherein the server forms a single data session with a user device of the person to complete Fast Identity Online (FIDO) authentication of the person and to complete a facial identification using the identity document and the photo of the person.
